(19) United States
(12) Patent Application Publication
(10) Pub. No.: US 2018/0056580 A1
(43) Pub. Date: Mar. 1, 2018

(54) MANUFACTURING METHOD FOR THREE-DIMENSIONAL OBJECT AND THREE-DIMENSIONAL STRUCTURE

(71) Applicant: MIMAKI ENGINEERING CO., LTD., Nagano (JP)

(72) Inventors: Kazuhiro OCHI, Nagano (JP); Hiroyoshi OHI, Nagano (JP); Kohei KOBAYASHI, Nagano (JP)

(21) Appl. No.: 15/683,105

(22) Filed: Aug. 22, 2017

(30) Foreign Application Priority Data
Aug. 30, 2016 (JP) 2016-167709

(51) Int. Cl. B29C 64/112; B41J 2/01; B33Y 10/00; B29C 64/40; B33Y 80/00

(52) U.S. Cl. CPC B29C 64/112; B41J 2/01; B29K 2105/0058; B29C 64/40; B33Y 80/00; B33Y 10/00

(57) ABSTRACT

The method includes a three-dimensional structure forming step of stacking the ink layers to form a three-dimensional structure including the three-dimensional object and a support member that supports the three-dimensional object, and a separating step of separating the support member from the three-dimensional object subsequent to the three-dimensional structure forming step. Subsequent to the separating step, the support member is combined with the three-dimensional object to protect the three-dimensional object.

### CROSS REFERENCE TO RELATED APPLICATIONS

This application claims the priority benefit of Japanese Patent Application No. 2016-167709, filed on Aug. 30, 2016. The entirety of the above-mentioned patent application is hereby incorporated by reference herein and made a part of this specification.

### TECHNICAL FIELD

This disclosure relates to a manufacturing method for a three-dimensional object. This disclosure further relates to a three-dimensional structure including a predetermined three-dimensional object.

### DESCRIPTION OF THE BACKGROUND ART

So far, methods of manufacturing predetermined three-dimensional objects have been disclosed (for example, Japanese Unexamined Patent Publication No. 2015-71282). The three-dimensional object manufacturing method described in Japanese Unexamined Patent Publication No. 2015-71282 starts with a step of discharging a mold release material from an ink jet head toward a working plane to form a mold release layer on the working plane. Then, the steps below are performed repeatedly: a step of discharging a molding material and a mold release material from the ink jet head; and a step of fully or half curing the molding material discharged in order to form a three-dimensional object, a support, and a mold release layer. Thus, the method forms the three-dimensional object, the support that supports the three-dimensional object, and the mold release layer between the three-dimensional object and the support. Then, the support-attached three-dimensional object is removed from the working plane, and the support is removed from the three-dimensional object to obtain the three-dimensional object as a completed product.

### SUMMARY

The three-dimensional object obtained by the manufacturing method described in Japanese Unexamined Patent Publication No. 2015-71282 may be packaged and shipped out. In this instance, a protective material for protecting the three-dimensional object may be necessary to prevent possible damage to the object during transportation. However, providing adequate protection for three-dimensional objects using any protective materials may be rather difficult to achieve. When an air bubble sheet is used as the protective material, for example, a three-dimensional structure article may be wrapped around with the sheet so as to protect the article. This may involve a risk of damage to the three-dimensional structure article during an attempt to wrap the sheet around the article. A protective member specially designed to protect the three-dimensional object could be additionally prepared, which, however, leads to cost increase.

To address these issues, this disclosure is directed to providing a three-dimensional structure and a manufacturing method for a three-dimensional object that may provide adequate protection for the three-dimensional object during transportation and that may achieve a reduced shipping cost for the three-dimensional object.

A manufacturing method for a three-dimensional object disclosed herein is directed to manufacturing a three-dimensional object by stacking ink layers formed of an ink discharged from an ink jet head. The method includes a three-dimensional structure forming step of stacking the ink layers to form a three-dimensional structure including a three-dimensional object and a support member that supports the three-dimensional object, and a separating step of separating the support member from the three-dimensional object subsequent to the three-dimensional structure forming step. Subsequent to the separating step, the support member is combined with the three-dimensional object to protect the three-dimensional object.

In this manufacturing method, the three-dimensional object and the support member that supports the three-dimensional object are formed in the three-dimensional structure forming step, and the support member is separated from the three-dimensional object in the separating step. This method forms the support member along the shape of the three-dimensional object in the three-dimensional structure forming step. Subsequent to the separating step, the object-side surface of the support member may have a shape that follows the shape of the three-dimensional object. Subsequent to the separating step, the support member is combined with the three-dimensional object to protect the object. Thus, the three-dimensional object may be adequately protected with the object-side surface of the support member during transportation.

This method forms the three-dimensional object and the support member alongside in the three-dimensional structure forming step and the separating step. This may eliminate the need to prepare an additional member that protects the three-dimensional object during transportation. This method, therefore, may achieve a reduced shipping cost for the three-dimensional object as compared with cases where three-dimensional objects require additional means for protection during transportation.

The three-dimensional structure may further include a separator material between the three-dimensional object and the support member. The separator material may be formed of an ink that differs from the ink used to form the support member. In the separating step, the separator material may be stripped off to separate the support member from the three-dimensional object. The separator material may allow the support member to be readily removable from the three-dimensional object.

The separator material may be formed of an ink dissoluble in a predetermined solvent. In the separating step, the separator material may be dissolved away in the solvent by immersing the three-dimensional structure in the solvent to separate the support member from the three-dimensional object. The separator material formed of such an ink may be readily stripped off in the separating step.

The support member may have a plurality of holes. In the three-dimensional structure forming step, the ink may be discharged from the ink jet head in a manner that the separator material is at least partly formed in the plurality of holes. An ink dissoluble in a predetermined solvent may be used to form the separator material. In the separating step, the holes formed in the support member may allow the solvent to reach any positions in the separator material that the solvent would otherwise be difficult to reach. Therefore, the separator material, if formed of an ink dissoluble in a predetermined solvent, may be more readily stripped off in the separating step.

The support member may be provided in the form of a three-dimensional network. The support member may have, in a part thereof that supports the three-dimensional object subsequent to the separating step, a soft portion inferior in hardness to another portion of the support member. The support member thus structured may exert a shock-absorbing action on the three-dimensional object. This may effectively avoid possible damage to the three-dimensional object during transportation.

The support member may have transparency. The three-dimensional object may be formed in a complex shape. Yet, transparency of the support member may allow relative positions of the support member and the three-dimensional object to be visually checked during the process of combining the support member with the three-dimensional object. Therefore, the three-dimensional object, even if complexly shaped, may be prevented from being damaged during the process of combining the support member with the three-dimensional object.

This disclosure further provides a three-dimensional structure formed by curing an ink. The three-dimensional structure includes a three-dimensional object and a support member that supports the three-dimensional object. The support member is combined with the three-dimensional object after completion to protect the three-dimensional object.

The three-dimensional structure includes a three-dimensional object and a support member that supports the three-dimensional object. The support member is combined with the three-dimensional object after completion to protect the three-dimensional object. The support member is formed along the shape of the three-dimensional object, so that the object-side surface of the support member substantially matches the shape of the three-dimensional object. By combining the support member with the completed three-dimensional object, the three-dimensional object may be adequately protected with the object-side surface of the support member during transportation. The three-dimensional structure including the support member may dispense with an additional member to protect the three-dimensional object during transportation. This may achieve a reduced shipping cost for the three-dimensional object.

The support member may have, in a part thereof that supports the completed three-dimensional object, a soft portion inferior in hardness to another portion of the support member. The support member thus structured may exert a shock-absorbing action on the three-dimensional object. This may effectively avoid possible damage to the three-dimensional object during transportation.

As described thus far, this disclosure may provide adequate protection for the three-dimensional object during transportation and may achieve a reduced shipping cost for the three-dimensional object.

### BRIEF DESCRIPTION OF THE DRAWINGS

FIGS. 1A and 1B are drawings that illustrate a manufacturing method for a three-dimensional object according to an embodiment; and

FIGS. 2A to 2C are drawings that illustrate the structure of a support member according to another embodiment.

### DETAILED DESCRIPTION OF EMBODIMENTS

Embodiments of this disclosure are hereinafter described with reference to the accompanying drawings.

### Manufacturing Method for Three-dimensional Object

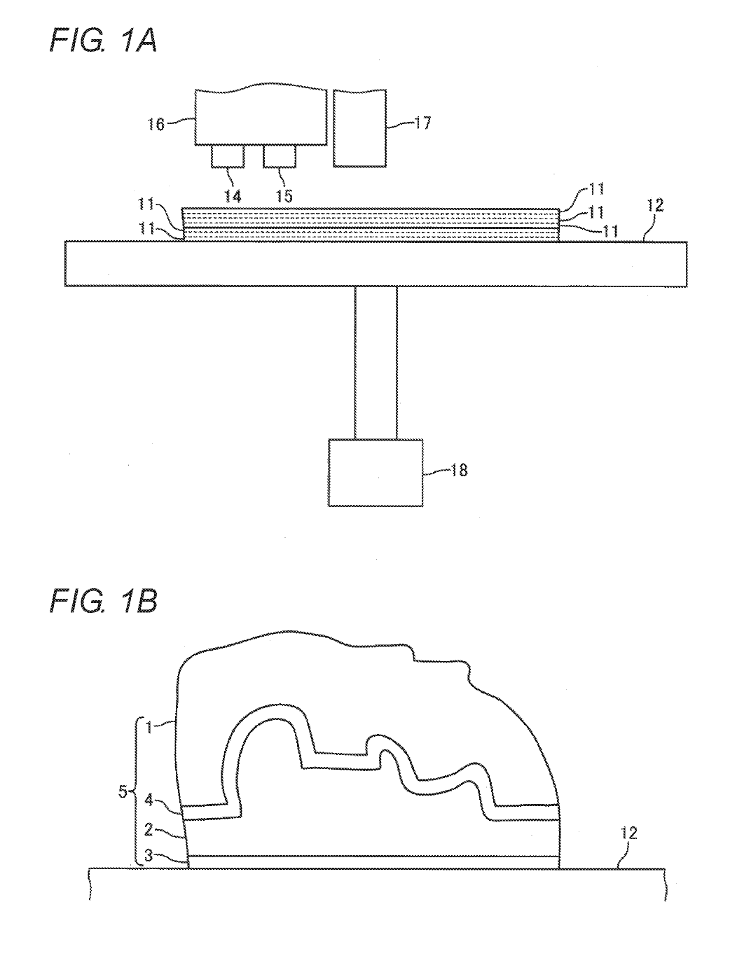

FIGS. 1A and 1B are drawings that illustrate a manufacturing method for a three-dimensional object according to an embodiment of the disclosure. The three-dimensional object manufacturing method according to this embodiment includes a three-dimensional structure forming step, a separating step, and a combining step, which are performed in this order.

In the three-dimensional object manufacturing method according to this embodiment, ink layers 11 formed of inks discharged from ink jet heads 14 and 15 are stacked on one another on the upper surface of a table 12 to manufacture a three-dimensional object 1. The manufacture of the three-dimensional object 1 is described in detail below. The ink layers 11 are stacked on one another to form a three-dimensional structure 5 including the three-dimensional object 1, a support member 2, a support material 3, and a support material 4 (three-dimensional structure forming step). The support member 2 is formed to support the three-dimensional object 1 and is combined with the three-dimensional object 1 after completion to protect the object during transportation. The support material 3 is formed between the support member 2 and the table 12 to support the three-dimensional object 1. The support material 4 is an example of the separator material and is formed between the three-dimensional object 1 and the support member 2 to support the three-dimensional object 1.

A modeling material, an example of inks for three-dimensional objects, is used to form the three-dimensional object 1 and the support member 2. The support materials 3 and 4 are formed of a support ink. Thus, different inks are used to the three-dimensional object 1 and the support member 2 and to form the support materials 3 and 4. The ink jet head 14 discharges the modeling ink that forms the three-dimensional object 1 and the support member 2. The ink jet head 15 discharges the support ink that forms the support materials 3 and 4. Hereinafter, the ink jet head 14 is referred to as “modeling ink discharger 14”, and the ink jet head 15 is referred to as “support ink discharger 15”.

The ink discharged from the modeling ink discharger 14 is an ink curable by active energy line. A specific example of the ink may be an ultraviolet-curable ink, which is cured by being irradiated with ultraviolet light. The ink discharged from the support ink discharger 15 is also an ink curable by active energy line, specifically, an ultraviolet-curable ink. The ink discharged from the support ink discharger 15 is dissoluble in a predetermined solvent, specifically, a water-soluble ink, in which case water may be used as a solvent. The support materials 3 and 4 are thus formed of a water-soluble ink.

The modeling ink discharger 14 and the support ink discharger 15 are mounted in a carriage 16 and located at a position in the upper direction of the table 12. An ultraviolet irradiator 17 is disposed at a position in the upper direction of the table 12. The ultraviolet irradiator 17 is moved for scan solely or together with the modeling ink discharger 14 and the support ink discharger 15 to irradiate the inks discharged from these ink dischargers with ultraviolet light. The ultraviolet irradiator 17 may radiate ultraviolet light to the whole upper surface of the table 12. FIG. 1A is a drawing of the ultraviolet irradiator 17 allowed to move for scan. An up-down moving mechanism 18 is coupled to the table 12. The table 12 is moved by this mechanism upward and downward. The up-down moving mechanism 18 is a vertical drive unit that changes vertical positions of the modeling ink discharger 14 and the support ink discharger 15 relative to the upper surface of the table 12. The upper surface of the table 12 is coated with an anodized aluminum film.

In the three-dimensional structure forming step, an amount of ink for one layer is discharged from at least one of the modeling ink discharger 14 and the support ink discharger 15. The modeling ink discharger 14 discharges the ink toward a region in which part of the three-dimensional object 1 will be formed and a region in which part of the support member 2 will be formed. The support ink discharger 15 discharges the ink toward a region in which part of the support materials 3 and 4 will be formed. The discharged inks are irradiated with ultraviolet light radiated from the ultraviolet irradiator 17 to be fully or half cured to form one ink layer 11. After one ink layer 11 is formed, the table 12 moves downward by a dimension equal to the thickness of the ink layer 11. After the downward movement of the table 12, at least one of the modeling ink discharger 14 and the support ink discharger 15 discharges the ink in an amount for a next layer. The discharged inks are is irradiated with ultraviolet light radiated from the ultraviolet irradiator 17 to be fully or half cured to form a next ink layer 11.

In the three-dimensional structure forming step, the inks are discharged and cured (full or half cure) and the table 12 is moved downward, which are performed repeated times. As a result, the three-dimensional structure 5 is formed that includes the three-dimensional object 1, support member 2, and support materials 3 and 4, as illustrated in FIGS. 1A and 1B. The inks are thus discharged and cured to form the three-dimensional structure 5 on the table 12. In this embodiment, the three-dimensional object 1, support material 4, support member 2, and support material 3 are arranged on one another from the top in the mentioned order, as illustrated in FIG. 1B. The support material 3 also serves to level out minute irregularity on the upper surface of the table 12, so that the table 12 has a smooth upper surface.

After the three-dimensional structure 5 is formed by the three-dimensional structure forming step, the support materials 3 and 4 are removed to separate the support member 2 from the three-dimensional object 1 (separating step). As described earlier, the support materials 3 and 4 are formed of a water-soluble ink. In the separating step, the three-dimensional structure 5 is detached from the table 12 and immersed in water to dissolve away the support materials 3 and 4 in water. By thus stripping off these support materials, the three-dimensional object 1 and the support member 2 are separated from each other. After the support materials 3 and 4 are stripped off, the three-dimensional object 1 and the support member 2 are finally obtained.

The three-dimensional object 1 and the support member 2 are separately obtained, and are then put together (combining step). Specifically, the three-dimensional object 1 and the support member 2 are put together, so that the upper surface of the support member 2 and the lower surface of the three-dimensional object 1, as illustrated in FIG. 1B, are in contact with each other. The support member 2 is combined with the three-dimensional object 1 after completion to protect the object 1. The three-dimensional object 1 with the support member 2 is packed in a box and transported. At the destination, the three-dimensional object 1 with the support member 2 is taken out of the box, and the support member 2 is removed from the three-dimensional object 1.

The support material 4 has a thickness large enough to invite water into between the three-dimensional object 1 and the support member 2 in the separating step. The thickness of the support material 4 may be approximately a few millimeters. In the three-dimensional structure 5, the support material 4 has a uniform thickness, and the upper surface of the support member 2 has a shape that follows the lower surface of the three-dimensional object 1. To be more specific, the upper surface of the support member 2 has a shape that substantially matches the lower surface of the three-dimensional object 1.

### Effect of This Embodiment

The manufacturing method according to this embodiment includes the steps below. The three-dimensional structure forming step forms the three-dimensional object 1 and the support member 2 that protects the three-dimensional object 1, and further forms the support material 4 between the three-dimensional object 1 and the support member 2. The subsequent separating step removes the support material 4 to separate the support member 2 from the three-dimensional object 1. The support material 4 has a uniform thickness, and the upper surface of the support member 2 has a shape that follows the lower surface of the three-dimensional object 1. In the combining step subsequent to the separating step, the three-dimensional object 1 and the support member 2 are put together, so that the upper surface of the support member 2 and the lower surface of the three-dimensional object 1 are in contact with each other. According to this embodiment, the three-dimensional object 1 combined with the support member 2 may be adequately protected with the support member 2 during transportation.

The three-dimensional structure 5 has the support member 2 formed between the support materials 3 and 4. This may reduce usage of the support ink in the three-dimensional structure forming step as compared with cases where, for example, a three-dimensional structure 5 has a portion in which the support member 2 is replaced with the support material. The three-dimensional object 1 and the support member 2 are formed alongside in the three-dimensional structure forming step and the separating step. This may eliminate the need to prepare an additional member that protects the three-dimensional object 1 during transportation. In the three-dimensional structure 5 according to this embodiment, overall manufacturing and shipping costs for the three-dimensional object 1 may be reduced as compared with, for example, a three-dimensional structure which has a portion where the support member 2 is replaced with the support material and which requires an additional member to protect the three-dimensional object 1 during transportation.

The support materials 3 and 4 are formed of a water-soluble ink. In the separating step, the three-dimensional structure 5 is immersed in water to dissolve away the support materials 3 and 4 in water. In this manner, the support materials 3 and 4 may be readily stripped off in the separating step.

### First Modified Example of Support Member

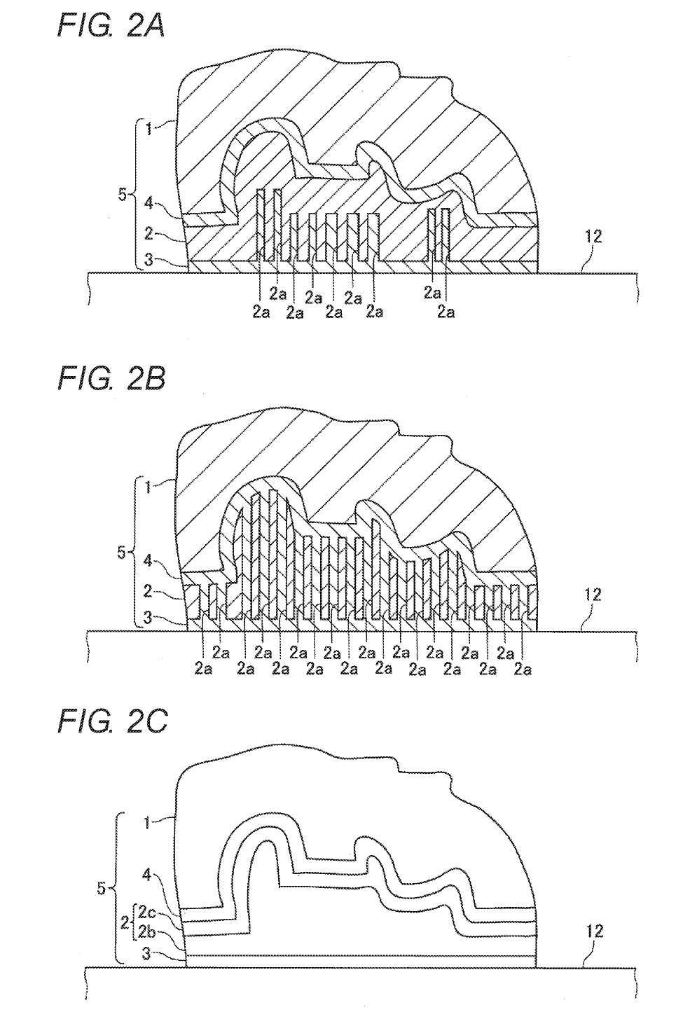

In the embodiment described earlier, a plurality of holes 2a may be formed in the support member 2 after the support materials are stripped off (see FIG. 2A). In the modified example illustrated in FIG. 2A, the holes 2a formed in the support member 2 are extending upward from its bottom surface to an extent that these holes do not penetrate through the support member 2. The hole 2a has a circular shape or a rectangular shape when observed from its top or bottom. In the three-dimensional structure 5, the support material 3 is partly formed in the holes 2a. To this end, the support ink is discharged from the support ink discharger 15 in the three-dimensional structure forming step in a manner that the support material 3 is partly formed in the holes 2a. The modeling ink is generally more expensive than the support ink. The modified example illustrated in FIG. 2A may achieve low-cost manufacture of the support member 2 by reducing usage of the costly modeling ink.

How many holes 2a should be formed and where they should be formed may be decided so that the support member 2 is strong enough to adequately protect the three-dimensional object 1. The holes 2a may be formed in the periphery of a rather fragile portion of the three-dimensional object 1 without any contact of the three-dimensional object 1 with the support member 2. The fragile portion of the three-dimensional object 1 may be a finely structured portion of the three-dimensional object 1. In cases where the three-dimensional object 1 is a doll, its fingertips may be easily breakable. Even before manufacture of the three-dimensional object 1 starts, such an easily breakable portion may be detected from data used to manufacture the three-dimensional object 1.

### Second Modified Example of Support Member

In the modified example illustrated in FIG. 2A, the holes 2a are formed in the support member 2 vertically upward from its bottom surface to an extent that these holes do not penetrate through the support member 2. The holes 2a formed in the support member 2 after the support materials are stripped off may instead be through holes penetrating through the support member 2 from its bottom surface to upper surface (see FIG. 2B). In the three-dimensional structure 5, the support materials 3 and 4 are partly formed in the holes 2a. To this end, the support ink is discharged from the support ink discharger 15 in the three-dimensional structure forming step in a manner that the support materials 3 and 4 are partly formed in the holes 2a. The modified example illustrated in FIG. 2B may achieve low-cost manufacture of the support member 2, as with the modified example of FIG. 2A. In the modified example illustrated in FIG. 2B, the holes 2a may allow water to reach, in the separating step, any positions in the support material 4 that water would otherwise be difficult to reach. In this modified example, the support material 4 may be more readily stripped off in the separating step.

The support member 2 with the penetrating holes 2a may be provided in the form of a three-dimensional network or a sponge. The support member thus structured may exert a shock-absorbing action on the three-dimensional object 1. This may effectively avoid possible damage to the three-dimensional object 1 during transportation. Depending on the shape of the three-dimensional object 1, the holes 2a may be formed in a manner that the support material 4 is only partly formed in the holes 2a.

### Third Modified Example of Support Member

In the earlier embodiments, the support member 2 may have a hard portion 2b on a side thereof closer to the support material 3, and a soft portion 2c on a side thereof closer to the support material 4 as illustrated in FIG. 2C. The soft portion 2c is interior in hardness to the hard portion 2b. Specifically, the support member 2 may have, in a portion thereof in contact with the support material 4, the soft portion 2c inferior in hardness to another portion (i.e., hard portion) of the support member 2. In other words, the support member 2 may have the soft portion 2c in a portion thereof that supports the three-dimensional object 1 subsequent to the separating step (portion that supports the completed three-dimensional object 1). In this instance, a soft material ink discharger serving as an ink jet head that discharges an ink to form the soft portion 2c, is further mounted in the carriage 16. The hard portion 2b is formed of the ink discharged from the modeling ink discharger 14, while the soft portion 2c is formed of the ink discharged from the soft material ink discharger. When the support member 2 thus structured is combined with the three-dimensional object 1 in the combining step, the soft portion 2c and the three-dimensional object 1 contact each other. The support member 2, with the soft portion 2c on the side closer to the support material 4, may exert a shock-absorbing action on the three-dimensional object 1. This may effectively avoid possible damage to the three-dimensional object 1 during transportation.

### Fourth Modified Example of Support Member

In the earlier embodiments, the three-dimensional object 1 and the support member 2 are put together, so that the upper surface of the support member 2 and the lower surface of the three-dimensional object 1, as illustrated in FIG. 1B, are in contact with each other, and the support member 2 supports the three-dimensional object 1 from below. Optionally, the support member 2 supporting the three-dimensional object 1 from below may be formed so as to partly cover the three-dimensional object 1 from above or to cover the whole three-dimensional object 1. In this instance, the three-dimensional structure 5 likewise has the support material 4 between the support member 2 and the three-dimensional object 1. The support member 2, if formed so as to cover the whole three-dimensional object 1, may be evenly divided into two vertical or horizontal parts, or may be evenly divided into three or more vertical or horizontal parts.

In the earlier embodiments, the three-dimensional object 1 and the support member 2 are put together, so that the upper surface of the support member 2 and the lower surface of the three-dimensional object 1, as illustrated in FIG. 1B, are in contact with each other. Instead, a predetermined shock-absorbing material may be disposed between the upper surface of the support member 2 and the lower surface of the three-dimensional object 1. Optionally, part of the three-dimensional object 1 may be protected with the support member 2 during transportation, while the rest of the three-dimensional object 1 may be protected with a shock-absorbing material such as styrene foam contained with the three-dimensional object 1 in a packaging box.

### Other Embodiment

The support member 2 may have transparency. The three-dimensional object 1 may be formed in a complex shape. Yet, transparency of the support member may allow relative positions of the support member 2 and the three-dimensional object 1 to be visually checked when the support member 2 and the three-dimensional object 1 are put together in the combining step. Therefore, the three-dimensional object 1, even if complexly shaped, may be prevented from being damaged during the process of combining the support member 2 with the three-dimensional object 1.

Instead of using the same ink to form the three-dimensional object 1 and the support member 2 as described in the earlier embodiments, different inks may be used to form the three-dimensional object 1 and to form the support member 2. In this instance, the support material 4 between the three-dimensional object 1 and the support member 2 may be unnecessary in so far as the three-dimensional object 1 and the support member 2 are separable in the separating step.

The ink used to form the support materials 3 and 4 may be, instead of a water-soluble ink, an ink dissoluble in any solvent but water (for example, organic solvent).

While the ultraviolet-curable ink is used to form the support materials 3 and 4 in the earlier embodiments, any other type of ink that can be discharged from the support ink discharger 15 and stripped off in the separating step may be used to form the support materials 3 and 4.

In the earlier embodiments, the three-dimensional structure 5 has the support member 2, support material 4, and three-dimensional object 1, which are arranged from the bottom in the mentioned order. The three-dimensional structure 5 may have the support member 2, support material 4, and three-dimensional object 1 arranged from the laterally outer side in the mentioned order.

What is claimed is:

1. A manufacturing method for a three-dimensional object, the method manufacturing a three-dimensional object by stacking ink layers formed of an ink discharged from an ink jet head, the method comprising:
a three-dimensional structure forming step of stacking the ink layers to form a three-dimensional structure including the three-dimensional object and a support member that supports the three-dimensional object; and
a separating step of separating the support member from the three-dimensional object subsequent to the three-dimensional structure forming step,
the support member being combined with the three-dimensional object subsequent to the separating step to protect the three-dimensional object.

2. The manufacturing method for a three-dimensional object according to claim 1, wherein
the three-dimensional structure further comprises a separator material between the three-dimensional object and the support member,
the separator material is formed of an ink that differs from the ink used to form the support member, and
in the separating step, the separator material is stripped off to separate the support member from the three-dimensional object.

3. The manufacturing method for a three-dimensional object according to claim 2, wherein
the separator material is formed of an ink dissoluble in a predetermined solvent, and
in the separating step, the separator material is dissolved away in the solvent by immersing the three-dimensional structure in the solvent to separate the support member from the three-dimensional object.

4. The manufacturing method for a three-dimensional object according to claim 2, wherein
the support member has a plurality of holes, and
in the three-dimensional structure forming step, the ink is discharged from the ink jet head in a manner the separator material is at least partly formed in the plurality of holes.

5. The manufacturing method for a three-dimensional object according to claim 1, wherein the support member is provided in the form of a three-dimensional network.

6. The manufacturing method for a three-dimensional object according to claim 1, wherein the support member has, in a portion thereof that supports the three-dimensional object subsequent to the separating step, a soft portion inferior in hardness to another portion of the support member.

7. The manufacturing method for a three-dimensional object according to claim 1, wherein the support member has transparency.

8. A three-dimensional structure formed by curing an ink, comprising:
a three-dimensional object and a support member that supports the three-dimensional object, the support member being combined with the three-dimensional object after completion to protect the three-dimensional object.

9. The three-dimensional structure according to claim 8, wherein the support member has, in a portion thereof that supports the three-dimensional object after completion, a soft portion inferior in hardness to another portion of the support member.

10. The manufacturing method for a three-dimensional object according to claim 3, wherein
the support member has a plurality of holes, and
in the three-dimensional structure forming step, the ink is discharged from the ink jet head in a manner the separator material is at least partly formed in the plurality of holes.

11. The manufacturing method for a three-dimensional object according to claim 2, wherein the support member is provided in the form of a three-dimensional network.

12. The manufacturing method for a three-dimensional object according to claim 3, wherein the support member is provided in the form of a three-dimensional network.

13. The manufacturing method for a three-dimensional object according to claim 4, wherein the support member is provided in the form of a three-dimensional network.

14. The manufacturing method for a three-dimensional object according to claim 10, wherein the support member is provided in the form of a three-dimensional network.

15. The manufacturing method for a three-dimensional object according to claim 2, wherein the support member has, in a portion thereof that supports the three-dimensional object subsequent to the separating step, a soft portion inferior in hardness to another portion of the support member.

16. The manufacturing method for a three-dimensional object according to claim 3, wherein the support member has, in a portion thereof that supports the three-dimensional object subsequent to the separating step, a soft portion inferior in hardness to another portion of the support member.

17. The manufacturing method for a three-dimensional object according to claim 4, wherein the support member has, in a portion thereof that supports the three-dimensional object subsequent to the separating step, a soft portion inferior in hardness to another portion of the support member.

18. The manufacturing method for a three-dimensional object according to claim 5, wherein the support member has, in a portion thereof that supports the three-dimensional object subsequent to the separating step, a soft portion inferior in hardness to another portion of the support member.

19. The manufacturing method for a three-dimensional object according to claim 10, wherein the support member has, in a portion thereof that supports the three-dimensional object subsequent to the separating step, a soft portion inferior in hardness to another portion of the support member.

20. The manufacturing method for a three-dimensional object according to claim 11, wherein the support member has, in a portion thereof that supports the three-dimensional object subsequent to the separating step, a soft portion inferior in hardness to another portion of the support member.
